(19) United States
(12) Patent Application Publication
(10) Pub. No.: US 2001/0025712 A1
(43) Pub. Date: Oct. 4, 2001

(54) Waterloons

(76) Inventor: Jorge A. Pagan, College Park, GA (US)

Correspondence Address: JORGE A. PAGA'N, 1458 Riverwalk DR. APT.C, College Park, GA, 30349, US

(21) Appl. No.: 09/816,199

(22) Filed: Mar. 26, 2001

Related U.S. Application Data
(60) Provisional application No. 60/193,328, filed on Mar. 30, 2000.

(51) Int. Cl. A62C 3/02

(52) U.S. Cl. 169/70; 169/36

(57) ABSTRACT

Waterloons is an innovative apparatus used for aerial fighting of forest/wild fires. Rather than pouring water from a bucket-the current method used for this problem—water sealed in balloons would be dropped on the flames from directly above. This “sealed water” approach offers significant advantages over the “pouring” strategy. First, this invention would not cause water to evaporate—a process conducive to feeding the fire. It also ensures that water reach lower levels of the fire.

### CROSS-REFERENCE TO RELATED APPLICATIONS

A Provisional Patent Application No. 60/193,328 for this invention, also titled “Waterloons”, was previously filed with the Assistant Commissioner of USPTO on Mar. 30, 2000. The benefits and claims identified in that submission are consistent with the forthcoming information used to support this amended Non-Provisional Patent Application.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF INVENTION

Waterloons is a firefighting apparatus that expands existing balloon capability to include water transportation and extinguishment via aerial platform (s). Conventional aerial tactics used to fight forest fires involve a helicopter filling a bucket (affixed underneath its platform) by dropping it into a river or lake and transporting the liquid contents to the scene of a fire. Subsequently, the bucket opens from the bottom, thus causing a downward or descending release of water onto the apex of the flames. The following limitations are associated with this process. First, the water dropped on these flames are subjected to evaporation. Water descending from high altitude becomes raindrops. As a result, these drops do not have the force necessary to drown the fire at its base, which is the hottest part of a fire.

Instead of extinguishing the fire, these rain drops feed the fire. This reaction occurs because the water contains oxygen—a basic component of fire. Use of a balloon as a water extinguishing mechanism would result in a “saturated impact” on the flames, which would smother it. Furthermore, this invention would allow water to reach the base of the fire without losing its potency and/or smothering effect. In summation, this alternative approach would eliminate or reduce the current role oxygen has in connection with fire extinguishment from aerial platforms.

### BRIEF SUMMARY OF THE INVENTION

Waterloons is a firefighting apparatus that expands existing balloon capability to include water transportation and extinguishment via aerial platform (s). Conventional aerial tactics used to fight forest fires involve a helicopter filling a bucket (affixed underneath its platform) by dropping it into a river or lake and transporting its liquid contents to the scene of a fire. Subsequently, the bucket opens from the bottom, thus causing a downward or descending release of its water onto the apex of the flames. The following limitations are associated with this process. First, the water dropped on these flames are subjected to evaporation. Water descending from high altitude becomes raindrops. As a result, these drops do not have the force necessary to drown the fire at its base, which is the hottest part of a fire. Instead of extinguishing the fire, these rain drops feed the fire, because the water contains oxygen, which is a basic component of fire. The objective of this invention is to use a water filled balloon for aerial transportation and fire extinguishment.

### BRIEF DESCRIPTION OF THE SEVERAL VIEWS OF THE DRAWING

FIG. 1. Fixed or rotary aircraft used to transport bucket containing water, liquid or foam used to extinguish forest or building fire.

FIG. 2. Conventional bucket used to obtain and transport water to fire scene.

FIG. 3. Balloon apparatus constructed from latex or any type of elastic material capable of holding large volumes of water, liquids and extinguishing materials is release from bucket or plane.

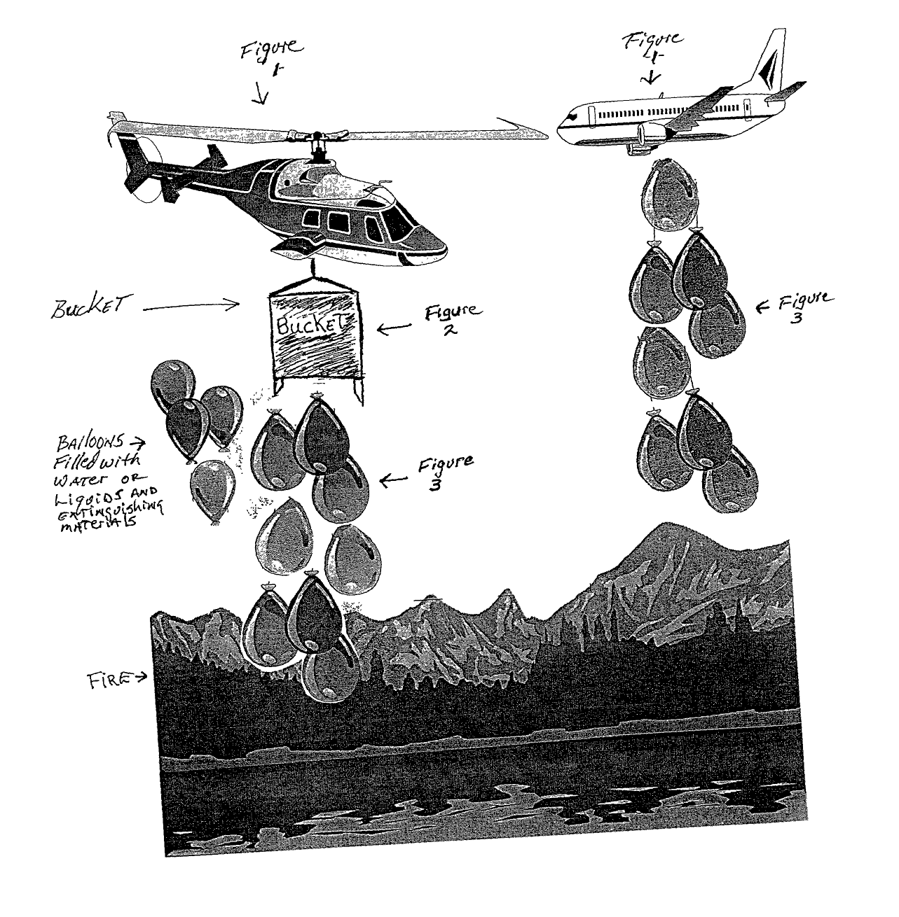

### DETAILED DESCRIPTION OF THE INVENTION

This invention expands existing latex or any type of raw material used to manufacture conventional balloons. Existing wild fire extinguishing tactics utilize aircraft containing a bucket underneath it to obtain water and transport it to the scene of the fire. Subsequently, this bucket releases the water from its bottom onto the fire. This technique posses several problems. First, by pouring water onto forest fires from an aerial platform, additional oxygen is generated from this process. Oxygen, a key component of fire, would be eliminated under this invention due to the fact that the water being dropped onto the fire would exist in a balloon like container. Upon contact with the fire's peak (treetops), Waterloons would burst and suspend its contents to the base of the fire, which is its greatest intensity point. Under existing aircraft-bucket tactics for fighting wildfires, water being poured evaporates and thus, is unable to reach lower levels of the flames. Elastic material balloons can be connected to the same buckets by insertion of a water hose interface device at the bottom of the latter apparatus. Cable instruments, functioning as straps or reinforcement mechanisms would also help maintain this interface with the bucket. A pulley based mechanical system can be used to elevate the buckets to the aircraft for purposes of affixing balloons either inside or underneath this container.

What I, Jorge A. Pagan claims as my invention is an apparatus for aerial platform fighting of forest/wild fires. Critical steps conducive to this claim incorporates the following key processes:

1. Expansion of elastic materials by constructing them into oversized balloon capable of transporting large quantities of water, foam or any type of fire extinguishing agent.

2. This balloon will be capable of being fastened or sealed once its has been filled with water from a bucket which will feed it.
